(19) United States
(12) Patent Application Publication
(10) Pub. No.: US 2001/0032145 A1
(43) Pub. Date: Oct. 18, 2001

(54) Method for using a web-based marketing and/or management tool

(76) Inventor: John E. Cronin, Milton, VT (US)

Correspondence Address: Attention: Ryan K. Simmons, Esq., IPCapitalGroup, Inc., Suite 325, 400 Cornerstone Drive, Williston, VT, 05495, US

(21) Appl. No.: 09/759,421

(22) Filed: Jan. 12, 2001

Related U.S. Application Data
(60) Provisional application No. 60/175,839, filed on Jan. 13, 2000.

(51) Int. Cl. G06F 17/60

(52) U.S. Cl. 705/26; 705/10

(57) ABSTRACT

A method for providing information to a least one potential customer from an individual business owner the individual business owner belonging to a group of many business owners, which includes the following steps. First, setting up a web-site on a server, the web-site being accessed via a network by using a group uniform resource locator (URL) address, and comprising business information being common to the group of many business owners, and customized information being customized to the individual business owner. Second, supplying collateral material to the at least one potential customer, the collateral material comprising the group URL referring to the web-site, and a first unique site-code. Third, accessing the web-site by the at least one potential customer using the group URL. Fourth, inputting the first unique site-code to an input field of the web-site by the at least one potential customer. Fifth, accessing the customized information to the individual business owner by the at least one potential customer.

### CROSS REFERENCE TO RELATED CO-PENDING APPLICATIONS

This application claims the benefit of U.S. provisional application Ser. No. 60/175839 filed on 01/13/00 and entitled METHOD FOR USING A WEB-BASED MARKETING AND/OR MANAGEMENT TOOL which is commonly assigned and the contents of which are expressly incorporated herein by reference.

### FIELD OF THE INVENTION

The present invention relates to web-based marketing and/or management, and in particular to a method relating to the same that allow multiple users to have their own web-sites under a single URL.

### BACKGROUND OF THE INVENTION

### The Internet

Web servers and web browsers operating across an Internet Protocol (IP) network are widely used to provide remote access to information stored on a host system. The public Internet and private Intranets are examples of such IP networks and use a communication protocol referred to as hypertext transfer protocol or (HTTP). The information is commonly packaged as multiple web pages created using a hypertext markup language (HTML), which can be interpreted by a web browser to generate the display to the user.

In general, Uniform Resource Locators (URL) are used to identify web pages located on web servers operating on the network. For example, the URL of the main web page for the White House is http://www2.whitehouse.gov. The protocol, located before the colon, indicates which protocol to use in requesting the web page; http means the web page is on the World Wide Web. The next part, www2.whitehouse.gov, is comprised of the hostname, www2, which identifies the computer server, and the domain name, whitehouse. The .gov extension identifies the computer as belonging to the United States government. Other common extensions are .com (commercial) and .edu (education). A user of a web browser can request a web page by entering the appropriate URL into the web browser. A request for a selected web page is then transmitted to the web server across the network. The web server receives the request and then packages and transmits the web page back to the web browser for display to the user.

Many times a user inputs data that is sent back to the server requesting the information. In order for the server to process and then use the input data from the user, the server must be configured with data table software and the active server page (ASP) code must be written, which links the data table information to the HTML output.

A programmer creates active server pages, which allow a database to be accessed. When a user logs onto a site that is run with the active server page, the active server page runs a program. Typically, the active server page creates a page on the web with an input data field on it. An input data field is a region of the web page designated for the input of data by the user, either through typing ASCII characters with a keyboard or selecting input text with the computer mouse. When a user inputs data into the input field on the web page and hits the enter key, the server obtains the input data as a variable or combination of variables and uses it as an internal “request variable” to the ASP program. Upon receiving the request variable, the database is opened and a request query is made to match up the request variable to the corresponding records in the appropriate field. If a match is found, the data is returned as a so-called session variable, which is then used in the rest of the active server page program, usually to reply with an updated page back to the user.

The interaction between the web servers and the web browsers across the IP network provides a relatively easy and increasing popular means for accessing remote information.

For an individual to set up their own web-site requires non-negligible expenditures and substantial technical knowledge, which usually translates into additional expenses. Typically, a specific domain name requires a registration fee. The server that hosts the individual domain name must be paid a monthly fee. The programs that run the data tables, and create the ASP and HTML code are costly. Further more, web programmers and facilitators between the programmers and the users are costly. Finally, keeping a site current requires time. Collectively, it costs thousands to tens of thousands of dollars to set up and maintain an interactive site.

### Multi-Level Marketing and E-Commerce

Multi-Level Marketing is a business plan for the distribution of products and/or services through independent agents, contractors, or distributors at different levels. An individual (first) distributor is compensated for both direct sales originating with the first distributor and on sales generated by one or more (second and succeeding) distributors who have been recruited directly or indirectly by the first distributor, the second and succeeding distributors form a network of distributors said to be “downline” of the first distributor.

Multi-Level Marketing companies, companies that use a multi-level marketing business plan, are moving their business to the Internet to take advantage of the flexibility of electronic commerce, also called e-commerce, and other information sharing capabilities. Like many companies that have a sales force, distributors, partners or members of multi-level marketing companies interact with customers, prospects, as well as other distributors, partners or members. Like large companies that have a sales force, multi-level marketing companies are moving their business onto the web to allow for e-commerce, prospecting and information transfer.

Unlike large companies, multi-level marketing companies have a distinct problem in that each distributor, partner or member is an independent business owner. Each independent business uses the parent company for some information, but the individual distributors, partners or members may have their own business information (such as business name, collateral material, pricing, etc.). Collateral material is marketing material such as business cards, letters, post-cards, audiotapes, compact disc, marketing brochures and email containing additional business information. In one example, collateral material could be a business card with the business owners name, business name and a web-site URL printed on it. This means that for the individual distributors to use the Internet, each would each have to develop his own web-site, since they want to be individually recognized, but associated with, the multi-level parent company. To add to this problem, most of the individual distributors do not have the resources to create their own web-site. What is needed is a way for the individual distributors to get involved in e-commerce and use the web in their businesses at a very low cost.

It would be advantageous to allow individual distributors, partners or members of a multi-level, or multi-level-like company to operate a web-based business that takes advantage of the infrastructure, product offerings, and other resources of large multi-level parent company, while maintaining the characteristics and strength of the individual distributor, partner or member. It would be further advantageous to use the Internet to initially contact or screen prospects or new customers.

### SUMMARY OF THE INVENTION

In general, in one aspect the invention features method for providing information to a least one potential customer from an individual business owner the individual business owner belonging to a group of many business owners, which includes the following steps. First, setting up a web-site on a server, the web-site being accessed via a network by using a group uniform resource locator (URL) address, and comprising business information being common to the group of many business owners, and customized information being customized to the individual business owner. Second, supplying collateral material to the at least one potential customer, the collateral material comprising the group URL referring to the web-site, and a first unique site-code. Third, accessing the web-site by the at least one potential customer using the group URL. Fourth, inputting the first unique site-code to an input field of the web-site by the at least one potential customer. Fifth, accessing the customized information to the individual business owner by the at least one potential customer.

Implementations of the invention may include one or more of the following features. The web-site may include a common group web-site, the common group web-site includes the business information being common to the group of many business owners. The web-site further may include a customized individual business owner web-site, the customized individual business owner web-site containing the information customized to the individual business owner information. The first unique site-code may be an individual business referral name. The first unique site-code may be a sequence of alphanumeric characters. The group web-site may further include proprietary information, and the individual business owner can access the proprietary information by inputting a second unique site-code. The second unique site-code may be an individual business name. The second unique site-code may be a sequence of alphanumeric characters. The collateral material may be an email address. The collateral material may be an email address that is an alias. The network may be the Internet, intranet or a private network.

The group may include more than one individual business owner, each individual business owner having a corresponding customized individual business owner web-site. The customized web-site may include information customized to the individual business owner.

After setting up the web-site, customized information customized to the individual business owner may be provided to the web-site. The providing of customized information customized to the individual business owner includes the following steps. First, providing a data table, the data table comprises at least two records, each record comprising a plurality of fields. Second, inputting into the plurality of fields the at least first unique site code and data comprising customized information to the individual business owner. Third, programming executable software code to access the data table and one of the at least two records by inputting the first unique site-code, and retrieving the customized information. Fourth, storing the data table and the executable software code on the server.

In general, in another aspect, the invention features a system for performing web-based marketing for an individual business owner wherein, the individual business owner belongs to a group of many business owners. The system includes the following. Collateral material comprising a group URL referring to a web-site, and a first unique site-code, wherein the collateral material is supplied to a potential client. A host computer, the host computer including a group web-site common to the group of many business owners, an individual owner's web-site, an executable software code and a database. The database includes the business information being common to the group of many business owners, and customized information to the individual business owner. A user computer connected to the host computer via a network allowing the potential client to access the business information common to the group of many business owners and the customized information to the individual business owner by accessing the host computer and the group web-site via the network.

The system network may be the Internet, intranet, or a private network. The first unique site-code may be a sequence of alphanumeric characters or a individual business referral name. The group web-site may further include proprietary information, and the individual business owner can access the proprietary information via a second unique site-code. The second unique site-code may be a sequence of alphanumeric characters or an individual business referral name. The group web-site may be accessed by using the group URL. The group web-site may display business information being common to the group of many business owners. The individual owner's web-site may display customized information to the individual business owner.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

FIG. 1 is a schematic representation of collateral material in the form of a business card.

FIG. 2 is a schematic diagram of a database security table.

FIG. 3 is a browser view of the various web-pages associated with an exemplary URL www.domain.com.

FIG. 4 is an exemplary web-page showing the various elements of the web-page.

FIG. 5 is a flow diagram of for using a web-based marketing and/or management tool.

FIG. 6 is a schematic diagram of the computer system for carrying out the web-based marketing and/or web-based management according to the present invention.

### DETAILED DESCRIPTION OF THE PREFERRED EMBODIMENT

The present invention relates to web-based marketing and/or management, and in particular to a method relating to the same that allow multiple users to have their own web-sites under a single URL.

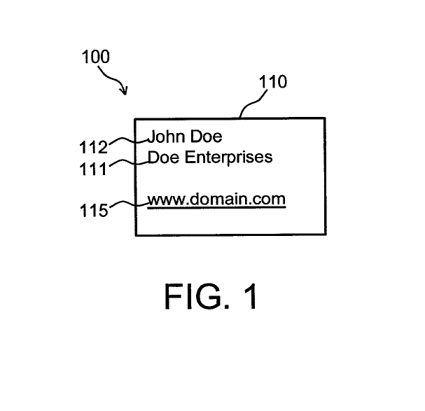

Referring to FIG. 1, collateral material 100 is developed for each distributor, partner or member of a multi-level corporation or business franchise. Collateral material 100 would include, but not be limited to, business cards 110, letters (not shown), post-cards (not shown), audiotapes (not shown), compact disc (not shown), and email (not shown). Business cards 110, includes a business name 111, a business owner's name 112 and a URL 115 of the distributor's web-site. Business cards 110, may further include additional information such as business owner's email address, mailing address, telephone number, voice messaging service, fax number, or alternate email address. The business owner's email address can either be an independent email address, or it can be a so-called alias. The alias allows the business owner to have an email address of the form jdoe@domain.com. When a visitor sends a message to jdoe@domain.com, the code relays the email to the distributor's independent email address.

In general, all distributors of the same group have the same group URL 115, but different business names 111. In one example John Doe, whose business name 111 is Doe Enterprises, has a URL 115 of www.domain.com. Likewise, if Jack Smith of Smith Enterprises were a member of the same group as John Doe, he would have the same URL 115 of www.domain.com.

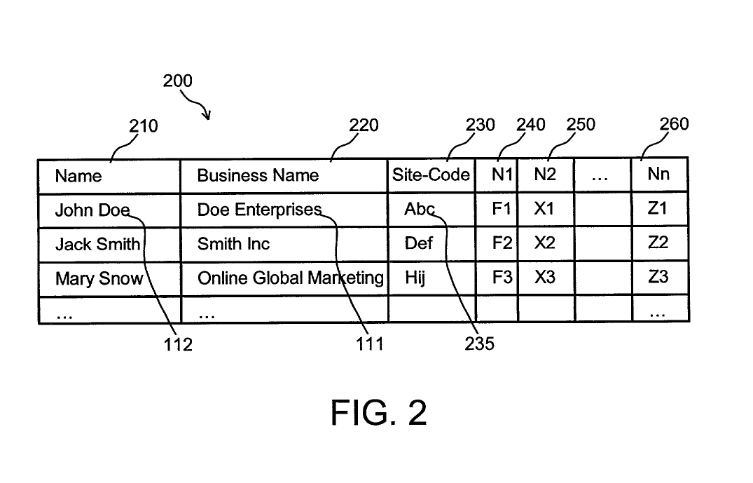

Referring to FIG. 2, database security table 200 exists on a server (not shown) with the names 112 of each distributor. In the table 200 there is a name column 210, which contains the individual distributor name 112, a distributor's business name column 220, which contains the individual distributor's business name 111. Database security table 200 further includes a private site-code column 230, which contains the individual distributors' site-code 235, and includes additional fields for any other information that is pertinent to the distributors. The columns N1 240 through Nn 260 represent any field that would be on the contacting site. In one instance N1 240 could be a graphic file of a distributor's logo. Column N2 250 could be the e-mail of the distributor. N3 (not shown) could be the address of the distributor. N4 (not shown) could be a distributor private message. N5 (not shown) could be a hyper link to another site. Each of these fields in the database security table 200 would reference a variable in the contacting site.

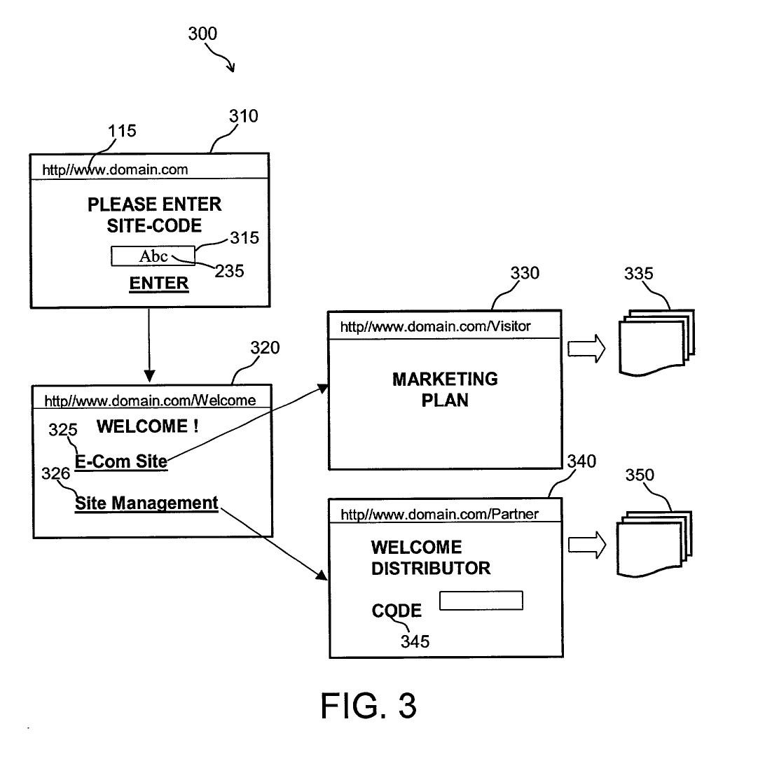

Referring to FIG. 3, a schematic view of browser view pages 300, with a logon web-page 310 appearing in the upper left-hand corner with the URL 115 of http://www.domain.com. This page appears the same for all distributors and contains a data input field 315 for the private site-code 235. When the business card 110 or other collateral material 100 is given to a prospect, the URL 115 identifies the web-site to log on to. The prospect, with the knowledge of the private site-code 235 given by the distributor, then logs onto the web-site through the distributor's account. The computer that hosts the web server software uses the entered site-code 235 to perform a table lookup in the database security table 200 to identify the appropriate distributor record.

For this reason, each site-code 235 in the database security table 200 must be unique, pointing to a unique distributor record. The information contained in this distributor record is then used to customize a collection of web-page templates each having a standard format. The prospect is then presented with the customized web pages, some with links to various other web pages for the prospect to see.

The next web-page presented would be a Welcome Page 320. On Welcome Page 320 an E-Com hyperlink 325, would further lead a prospect to a web-page 330 that would present a Marketing Plan, for example, of the multilevel business, or even to e-commerce pages, shown in FIG. 3 as a Visitor Site 335, that would advertise and/or allow the prospect to order product(s). There is also a Site Management link 326 presented on the Welcome Page 320. Site Management link 326 leads to a separate web page 340, and links for business training and management shown in FIG. 3 as Distributor Site 350. Prospects would be unable to get into the partner link because the partner access code 345 is not given to them. In this way, proprietary information can be shared between the parent company of the multilevel business and its distributors, and not with the client, customer, or prospect.

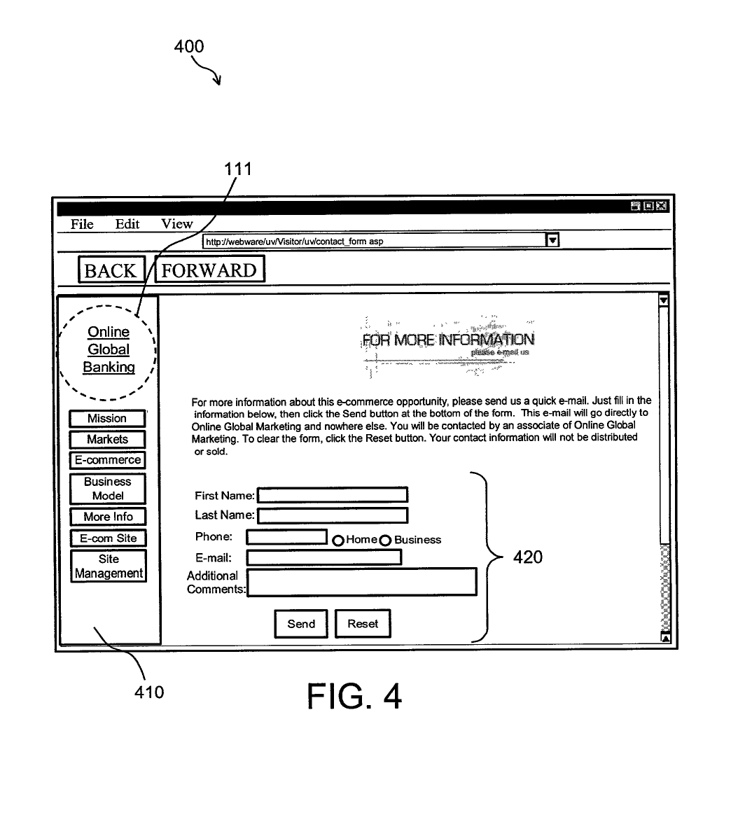

On each of the above web pages, the individual distributor's business identity 111, based on the information contained in the data security table 200, is clearly displayed as can be seen in a representative browser view page 400 contained in FIG. 4.

Referring to FIG. 4, illustrates a representative browser view 400 as it would appear had the prospect entered the private site-code 235 for the distributor known as “Mary Snow” in the database security table 200 of FIG. 2. Mary's business name 111 is “Online Global Marketing”, which then is displayed in a pre-determined position on the web-page 400 known as the Distributor Banner 410. Other forms of customization may include, but are not limited to, choice of Distributor Banner 410 background color, pictures of the distributor, company logos or slogans, or hyperlink information for use in directing the prospect to other web-pages of interest. In one sense the web-site is a boilerplate for information, where certain information is common to all distributors, and other information is pulled from the database security table 200 for each individual distributor. In one example, if John Doe's site code 235 is entered into the site-code field 315, all contacting site pages will have a Doe Enterprise Banner on it, and could include John Doe's picture, his address and e-mail, his biography, etc. When a user inputs Jack Smith into the referred by field, all contacting site pages will have Smith enterprises on it, with Jack Smith's picture, and Jack Smith's e-mail etc.

The user can also link to the response web page 400, as shown in FIG. 4, where the visitor can input data in a response field 420 to respond to the member or distributor who initially introduced him to the web-site. The response is sent directly to that member. The preferred method for sending the response information is via email, but alternative means include use of conventional postal service, notification of a third party who telephones the member, and automatic telephone messaging. With conventional postal service responses, the response is automatically printed out and mailed. The use of an automatic telephone messaging service would involve the code generating a sequence of commands that are linked to a voice generation system and connected to the telephone. Preferably, the message is sent directly to the individual business owner's automatic voice messaging service, but could alternatively be sent to his telephone directly where there may or may not be an answering machine ready to record the call.

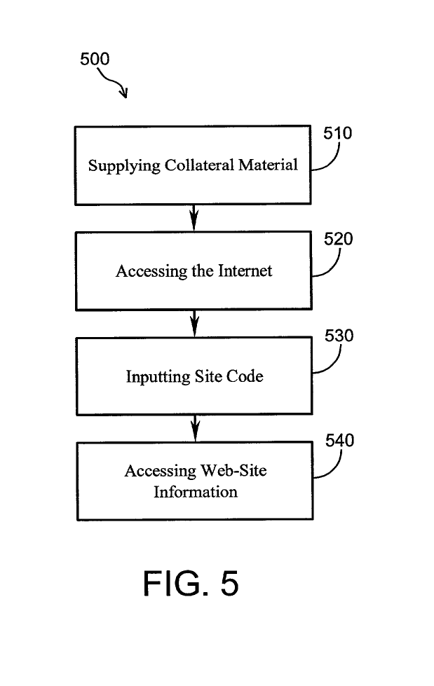

Referring to FIG. 5, a flow diagram for a method of using a web-based marketing and/or management tool 500, includes the following steps. In the first step, supplying collateral material 510, the client, customer or prospect is supplied with collateral material 100, which includes a group URL 115 and a referral name or site code 235. The group URL 115 refers to an internet site, which contains business information.

Next, accessing the Internet 520, the client, customer or prospect uses the supplied URL 115 to access the Internet. In the next step, inputting the site code 530, the client, customer or prospect inputs the supplied site-code 235 into the site code field 315, which is located on the logon web-page 310. In the final step, accessing web-site information 540, the client, customer or prospect accesses the web-site information, which is customized to the individual business owner's information.

The site code 235 could also consist of the distributor's, or referral's, name 112. Alternatively, the site code 235 could be a sequence of alphanumeric characters that would uniquely identify the distributor. Such a site code 235 would inhibit a visitor's ability to guess the names of other distributors in the business.

If a distributor would like to add another level of security and personalization, that distributor could buy a domain name, such as www.smithenterprises.com. When a client, customer or prospect accesses this web-site there it includes a simple descriptive page with a hyperlink to the welcome page 320 at www.domain.com. Here, the name of “referred by” or his access code 235 is required. This allows a distributor, partner or member to have his own URL 115, making it truly seem that the distributor, partner or member has his own totally independent site. It also keeps the cost low that is the distributor doesn't have to build the large “contacting site”.

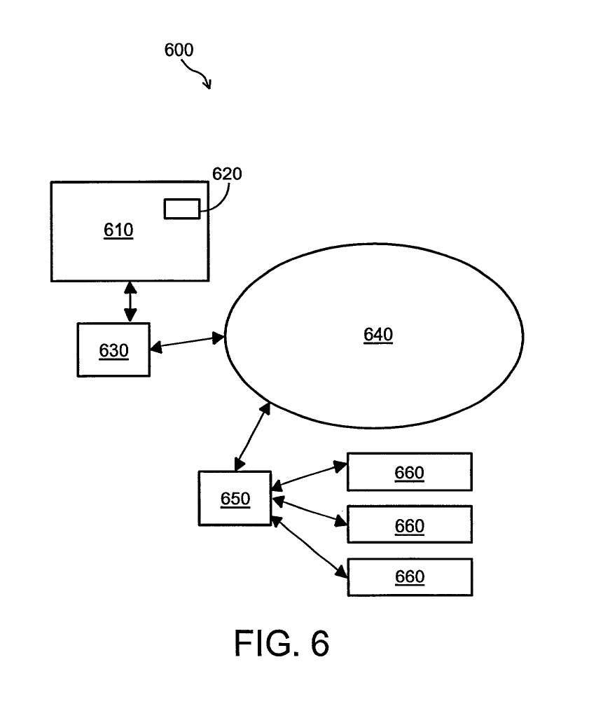

Referring to FIG. 6, the present invention is a computer system 600 that allows the method of the present invention to be carried out. The computer system comprises a host computer 610 with a database 620 (e.g., a computer-readable medium, such as a hard drive) loaded with a predetermined set of instructions (i.e., a computer program or webserver software) that instructs the host computer 610 to carry out the method of the present invention as described above. The host computer 610 is electronically linked to a first bi-directional router R1 630, which is electronically linked to the Internet 640. The computer system further includes a second bi-directional router R2 650 electronically linked to the Internet 640 and also electronically linked to one or more end user computers 660.

Among the advantages of this invention may be one or more of the following. One advantage of the invention is the individual distributor has access to a web “site” at a very low cost. The distributor might pay a small monthly fee to have his name and information in the table. A second advantage of the invention is the individual has a robust site that is customized to some level for his business. A larger parent company fulfils all of the technical requirements of building and maintaining a web-site. A third advantage of the invention is the parent company also ensures that the material present at the web-site, even though customized to each distributor, adheres to a common standard of quality and legality of the boilerplate information. A fourth advantage of the invention is the parent company also gains an additional channel by which to communicate directly with distributors, that channel being email. A fifth advantage of the invention is the distributor has a shared site to view information restricted to the distributor or gives access to a prospect where the prospect does not have access to distributor information.

The many features and advantages of the present invention are apparent from the detailed specification. Thus, it is intended by the appended claims to cover all such features and advantages of the described methods, which follow in the true spirit and scope of the invention. Furthermore, since numerous modifications and changes will readily occur to those of ordinary skill in the art, it is not desired to limit the invention to the exact construction and operation described herein. Accordingly, other embodiments are within the scope of the following claims.

What is claimed is:

1. A method for providing information to a least one potential customer from an individual business owner, said individual business owner belonging to a group of many business owners, the method comprising:
setting up a web-site on a server, said web-site being accessed via a network by using a group uniform resource locator (URL) address, and comprising business information being common to said group of many business owners, and customized information being customized to said individual business owner;
supplying collateral material to said at least one potential customer, said collateral material comprising said group URL referring to said web-site, and a first unique site-code;
accessing said web-site by said at least one potential customer using said group URL;
inputting said first unique site-code to an input field of said web-site by said at least one potential customer; and
accessing said customized information to said individual business owner by said at least one potential customer.

2. The method of claim 1 wherein said web-site comprises a common group web-site, said common group web-site comprising said business information being common to said group of many business owners.

3. The method of claim 1 wherein said web-site further comprises a customized individual business owner web-site, said customized individual business owner web-site containing said information customized to said individual business owner information.

4. The method of claim 1 wherein said first unique site-code comprises an individual business referral name.

5. The method of claim 1 wherein said first unique site-code comprises a sequence of alphanumeric characters.

6. The method of claim 2 wherein said group web-site further comprises proprietary information, and said individual business owner can access said proprietary information by inputting a second unique site-code.

7. The method of claim 6 wherein said second unique site-code comprises an individual business name.

8. The method of claim 6 wherein said second unique site-code comprises a sequence of alphanumeric characters.

9. The method of claim 1 wherein said collateral material comprises an email address.

10. The method of claim 1 wherein the collateral material comprises an email address that is an alias.

11. The method of claim 1 wherein said network comprises the Internet.

12. The method of claim 1 wherein said network comprises an intranet.

13. The method of claim 1 wherein said network comprises a private network.

14. The method of claim 1 wherein said group comprises more than one individual business owner, each individual business owner having a corresponding customized individual business owner web-site.

15. The method of claim 14 wherein said customized web-site comprises information customized to said individual business owner.

16. The method of claim 1 further comprising, after setting up said web-site, providing customized information customized to said individual business owner to said web-site.

17. The method of claim 16 wherein, said providing of customized information customized to said individual business owner comprises:
providing a data table, said data table comprises at least two records, each record comprising a plurality of fields;
inputting into said plurality of fields said at least first unique site code and data comprising customized information to said individual business owner;
programming executable software code to access said data table and one of said at least two records by inputting said first unique site-code, and retrieving said customized information; and
storing said data table and said executable software code on said server.

18. A system for performing web-based marketing for an individual business owner wherein, said individual business owner belongs to a group of many business owners, the system comprising:
collateral material comprising a group URL referring to a web-site, and a first unique site-code, wherein said collateral material is supplied to a potential client;
a host computer, said host computer comprising a group web-site common to said group of many business owners, an individual owner's web-site, an executable software code and a database, said database comprising said business information being common to said group of many business owners, and customized information to said individual business owner; and
a user computer connected to said host computer via a network allowing said potential client to access said business information common to said group of many business owners and said customized information to said individual business owner by accessing said host computer and said group web-site via said network.

19. The system of claim 18 wherein said network comprises the Internet.

20. The system of claim 18 wherein said network comprises an intranet.

21. The system of claim 18 wherein said network comprises a private network.

22. The system of claim 18 wherein said first unique site-code comprises a sequence of alphanumeric characters.

23. The system of claim 18 wherein said first unique site-code comprises an individual business referral name.

24. The system of claim 18 wherein said group web-site further comprises proprietary information, and said individual business owner can access said proprietary information via a second unique site-code.

25. The system of claim 18 wherein said second unique site-code comprises a sequence of alphanumeric characters.

26. The system of claim 18 wherein said second unique site-code comprises an individual business referral name.

27. The system of claim 18 wherein said group web-site is accessed by using said group URL.

28. The system of claim 18 wherein said group web-site displays business information being common to said group of many business owners.

29. The system of claim 18 wherein said individual owner's web-site displays customized information to said individual business owner.
